(19) United States
(12) Patent Application Publication
(10) Pub. No.: US 2004/0146200 A1
(43) Pub. Date: Jul. 29, 2004

(54) Segmenting touching characters in an optical character recognition system to provide multiple segmentations

(75) Inventors: Richard S. Andel, Binghamton, NY (US); Edward G. Ovando, Apalachin, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/353,885

(22) Filed: Jan. 29, 2003

(51) Int. Cl. G06K 9/34

(52) U.S. Cl. 382/177

(57) ABSTRACT

A method and computer program product are provided for classifying a character string. A plurality of candidate segmentations are determined for the character string, each ranked according to an associated score. At least two of the candidate segmentations are provided to a pattern recognition classifier. The character string is classified according to the highest-ranked candidate segmentation to obtain a first classified character string. An acceptor determines if the first classified character string is a valid character string. The classifier iteratively reclassifies the character string according to the ranked candidate segmentations until a valid character string is obtained if the first classified character string is not a valid character string.

### BACKGROUND OF THE INVENTION

1. Technical Field

The invention relates to a method and computer program product for identifying digitally scanned text in an optical character recognition (OCR) system. OCR systems rely on pattern recognition devices (classifiers) for character recognition.

2. Description of the Prior Art

Optical character recognition (OCR) is the process of transforming written or printed text into digital information. Pattern recognition classifiers are used in sorting scanned characters into a number of output classes. A typical prior art classifier is trained over a plurality of output classes using a set of training samples. The training samples are processed, data relating to features of interest are extracted, and training parameters are derived from this feature data. During operation, the system receives an input image associated with one of a plurality of classes. The input image is segmented into candidate objects and passed to a classifier. The relationship of each of the candidate objects to each class is analyzed via a classification technique based upon the training parameters. From this analysis, the system produces an output class and an associated confidence value for each of the candidate objects input to the classifier.

Ideally, all samples in an OCR system would be properly segmented into recognizable characters. In practice, however, a number of factors can cause characters to be read as touching. Any error in the printing or writing of the original or in the scanning of the sample can result in such an error. Even a speck of dirt in the wrong place can result in error. In most systems, touching characters will require separation before correct recognition can occur. Unless separated correctly, these merged characters will not be recognized by the classifier, necessitating repeated human intervention in the process.

Single character recognition has achieved accuracy levels on the order of ninety-nine percent. In some applications, however, such as mail processing, outside influences can reduce the scanning quality of images to cause characters to become touching or separated. These touching characters must be identified and either combined or separated in order to correspond to the actual input data. If not handled properly, these scanning imperfections will cause character recognition rates to drop significantly. Often, additional processing may be necessary to return the localized character image to a state similar to the original or classify the imperfect character image so that it can be mapped to a single-character classifier.

Frequently, it is possible to identify these missegmented characters by looking to additional characters within the character strings or the context of surrounding character strings. Incorporating such capabilities in the segmentation process, however, can greatly increase the complexity of the system and the processing time necessary for character segmentation. It would be desirable to selectively review the segmentation of various character strings without greatly increasing the complexity of the segmentation system.

### SUMMARY OF THE INVENTION

To this end, in accordance with one aspect of the invention, a method is disclosed for classifying a character string. A plurality of candidate segmentations are determined for the character string, each ranked according to an associated score. At least two of the candidate segmentations are provided to a pattern recognition classifier. The character string is classified according to the highest-ranked candidate segmentation to obtain a first classified character string. An acceptor determines if the first classified character string is a valid character string. The classifier iteratively reclassifies the character string according to the ranked candidate segmentations until a valid character string is obtained if the first classified character string is not a valid character string.

In accordance with another aspect of the invention, a computer program product is provided for classifying a character string. The computer program product included a segmentation portion that determines a plurality of candidate segmentations for the character string, each ranked according to an associated score, and outputs at least two of the candidate segmentations. A pattern recognition classifier receives at least two candidate segmentations and classifies the character string according to the highest-ranked candidate segmentation to obtain a first classified character string. An acceptor determines if the first classified character string is a valid character string. The classifier iteratively reclassifies the character string according to the ranked candidate segmentations until a valid character string is obtained if the first classified character string is not a valid character string.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a simplified example of an optical character recognition system that might be used in association with the present invention;

FIG. 2 is a flow diagram illustrating the run-time operation of the text segmentation device of the present invention;

FIG. 3 illustrates an example candidate object with four defined boundary lines;

FIG. 4 is a decision tree illustrating the combination of regions into complete sets; and

FIG. 5 is a functional block diagram of an example embodiment of the present invention implemented within a mail-processing system.

### DETAILED DESCRIPTION OF THE INVENTION

It should be noted that the present invention and any image recognition classifier to which the present invention is applied will likely be implemented as a computer program. Such a program may simulate, at least in part, the functioning of a neural network. As the present invention will be implemented as part of an optical character recognition system, a basic description of such a classification system would be useful in illustrating the claimed invention.

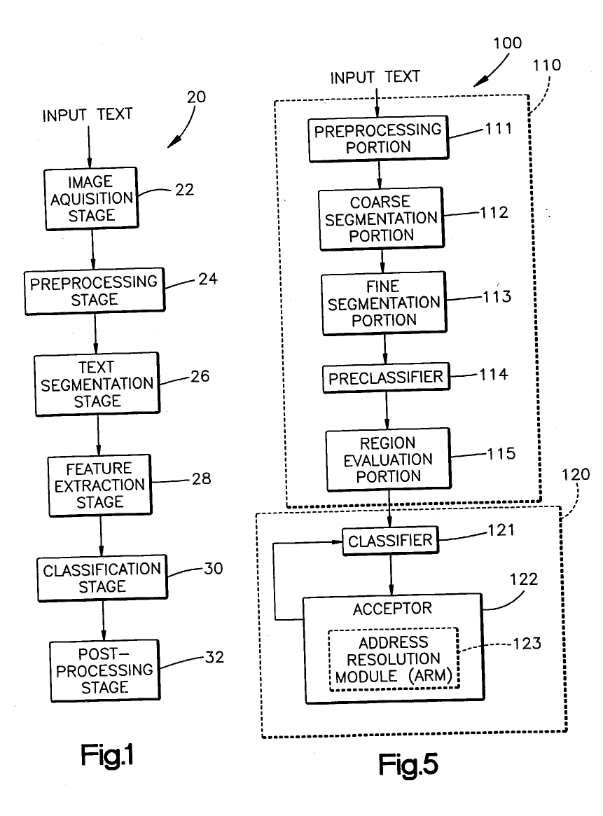

FIG. 1 illustrates a simplified example of an optical character recognition system 20 that might be used in association with the present invention. As stated above, the system is often implemented as a software program. Therefore, the structures described herein may be considered to refer to individual modules and tasks within that program.

Focusing on the function of an optical character recognition system 20, the classification process begins at an image acquisition stage 22 with the acquisition of an input image. In an optical character recognition system, the image will usually represent a quantity of text. The text is then sent to a preprocessing stage 24, where the text is preprocessed to enhance the text image, eliminate obvious noise, and otherwise prepare the candidate object for further processing.

The preprocessed text is then sent to a text segmentation stage 26. Segmentation is necessary to divide the text into units that roughly correspond to the output classes of the classification system. For example, a typical OCR system is trained to recognize single characters. Thus, the text segmentation stage 26 attempts to divide the text at the boundaries of the characters.

The segmented characters are then sent to a feature extraction stage 28. Feature extraction converts the segmented characters into a vector of numerical measurements, referred to as feature variables. The vector is formed from a sequence of measurements performed on the image. Many feature types exist and are selected based on the characteristics of the recognition problem.

The extracted feature vector is then provided to a classification stage 30. The classification stage 30 relates the feature vector to the most likely output class and determines a confidence value that the image is a member of the selected class. This is accomplished by a statistical or neural network classifier. The confidence value provides an external ability to assess the correctness of the classification. For example, a confidence value may have a value between zero and one, with one representing maximum certainty. Finally, the recognition result is sent to a post-processing stage 32. The post-processing stage 32 applies the recognition result provided by the classification stage 30 to a real-world problem.

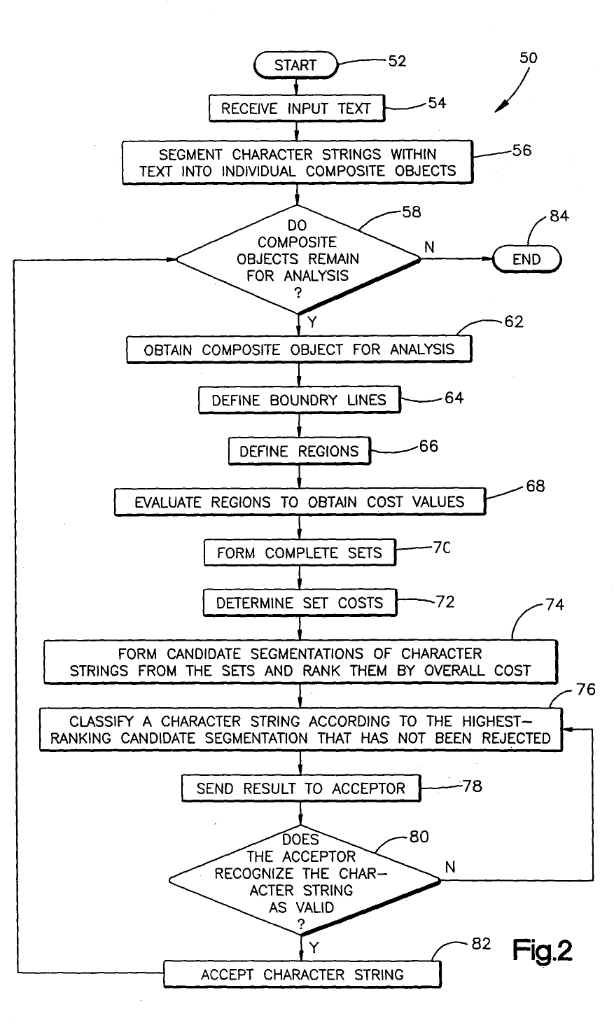

FIG. 2 is a flow diagram illustrating the run-time operation of the text segmentation device of the present invention. The process 50 begins at step 52. The process then proceeds to step 54, where the system receives a text sample for analysis. The text will generally be binarized, consisting of a number of rows and columns of dark and light pixels. A preliminary segmentation of the text is performed at step 56. During the preliminary segmentation, character strings within the text are divided into individual blocks of text. The coarse segmentation portion will attempt to divide the text into individual characters. Generally, however, candidate objects containing two or more characters will remain. Such candidate objects will be referred to hereinafter as composite objects. The coarse segmentation will simply attempt to segment characters by searching for some amount of background “white space” between the characters. Accordingly, the preliminary segmentation is relatively straightforward, and a number of methods are available in the art for performing this segmentation. Composite objects among the candidate objects are identified either by their width or, in a preferred embodiment, by a specialized preliminary classification module that determines if a particular candidate object contains touching characters.

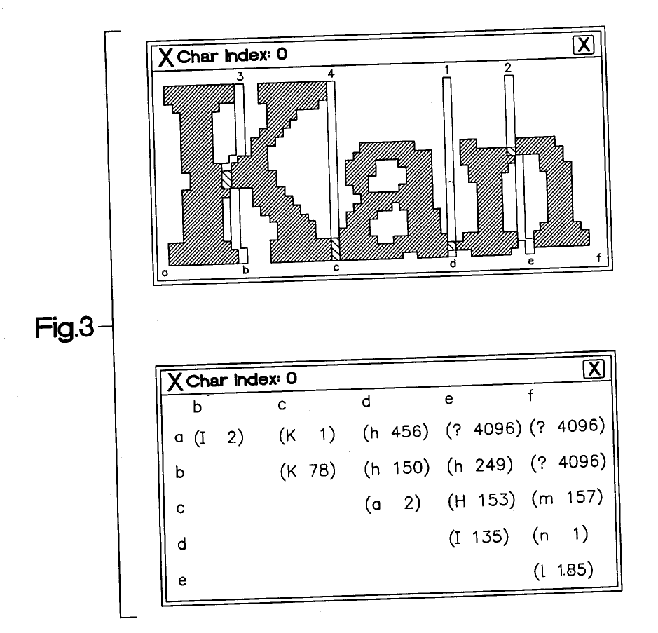

The process continues at step 58, where the system determines if there are composite objects available for analysis. If composite objects are available, the process continues to step 62, where the system obtains a composite object for analysis. The process continues at step 64, where boundary lines are defined within the block of text. The boundary lines can be defined via a number of methods, including placing vertical boundary lines at predetermined positions or by dividing the composite object into columns and splitting at the columns having the fewest dark pixels. In the example embodiment, the boundary lines are established using a least cost algorithm. After the boundary lines are defined, the process progresses to step 66, where the system defines a plurality of regions. The defined regions represent each possible combination of interior boundary lines within the composite object. An example composite object, with four interior boundary lines, is illustrated in FIG. 3. The interior boundaries are labeled “b”, “c”, “d”, and “e” for later reference. Similarly, the left and right exterior boundaries of the composite object are labeled “a” and “f” respectively.

A region is defined as the area between any two interior boundary lines, any interior boundary line and an exterior boundary, or the area between the two exterior boundaries. For a composite object containing a total of X interior boundary lines, where X is an integer less than a maximum allowed number of paths, the number of possible regions, R_{D}, can be determined as follows:

$${R}_{D} = \frac{( X + 2 ) ( X + 1 )}{2} \qquad Equation 1$$

The system will define and evaluate all possible regions that may be formed from within the composite object. In the example of FIG. 3, fifteen regions will be created and stored by the system. These regions are listed in the region score table of FIG. 3 according to their boundary lines. Generally, the number of interior boundary lines will be fairly small, making it unnecessary to store an exceedingly large number of regions.

Once the regions are defined and stored, the process continues to step 68, where the regions within each composite object are evaluated using one or more pattern recognition classifiers. These classifiers may include, for example, statistical or neural network classifiers. Since these classifiers are used to classify the individual regions prior to the actual classification of the composite object, they will be referred to collectively hereinafter as the region preclassifier. The individual regions are identified by the region preclassifier, which is trained to recognize a plurality of output classes according to a number of predefined features. Potentially useful features include the area of the region, the location of the top and bottom contours defined by the black pixels, the width of the region, and the number of transitions that an interior boundary line of the region makes from black to white pixels. In the example embodiment, the region preclassifier is trained to recognize single characters across a number of handwriting styles and fonts. Depending on the application, however, a preclassifier specific to a particular font or a preclassifier capable of classifying multi-character units may be preferable.

Each region, upon classification, becomes associated with a particular character and a score computed by the classifier. In the example embodiment, the score is a function of the confidence of one or more classifications of the region and the characteristic of the boundaries lines defining the region. FIG. 3 contains a region score table showing scores and associated output classes for each of the regions formed from the example composite object.

After the regions are classified, the process continues to step 70, where the regions of each composite object are combined into sets. It should be noted that only complete sets are considered in this analysis. A complete set is a set of regions that contains the entire area between the exterior boundaries of a composite object exactly once. For example, a complete set cannot contain both the region bounded by lines “b” and “d” and the region bounded by lines “c” and “e”, as this would result in overlap of the area bounded by lines “c” and “d”. Likewise, no area of the composite object may be omitted. For a given set of X interior boundary lines, there will be 2^{X} combinations of regions that comprise a complete set. Evaluating only complete sets ensures that necessary data will not be omitted and unnecessarily duplicative data will not be inputted to the classifier to distort later recognition of the composite object.

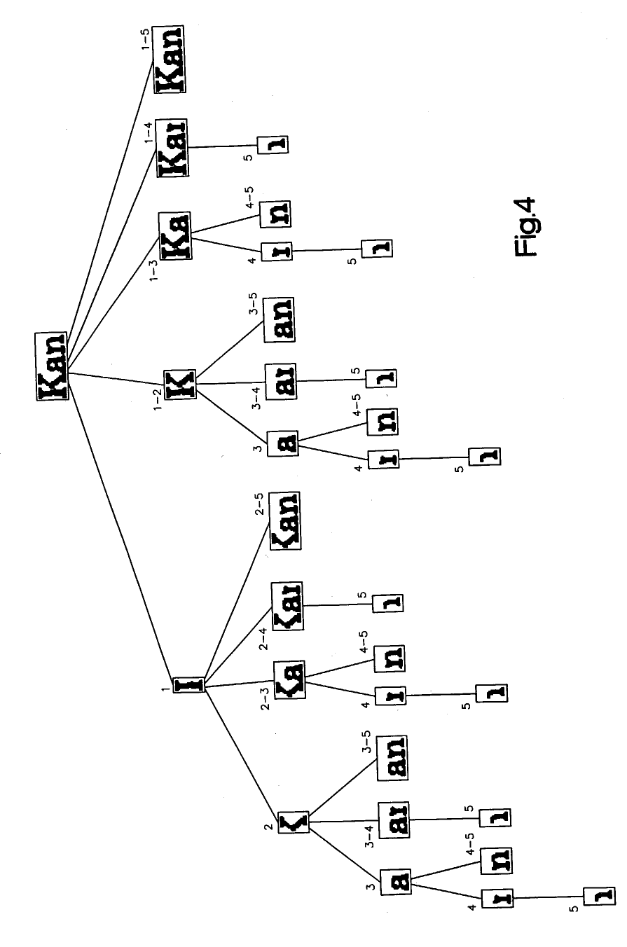

This process is best conceptualized as a decision tree such as is illustrated in FIG. 4. Each of the regions in the first row, all of which begin at “a”, the left boundary, begins a complete region set. The regions will be referred to as root nodes of the decision tree. Each of the regions on the right side, all of which end on “f”, the right boundary, provide the final region of a complete region set. These will be referred to as leaf or terminal nodes of the decision tree. Any path beginning at a root node and proceeding downward to terminate on a leaf node provides a complete set.

Once the sets are formed, the process continues to step 72, where an associated set score is derived from the scores associated with the regions comprising the set. This can be accomplished via a number of formulas. In the example embodiment, the set score is merely the sum of the associated scores of the regions comprising the set. In an alternate embodiment, the set score is derived from a weighted linear combination of the associated scores of the regions of the set. The sets are ranked according to their associated set score.

Once the set scores are calculated, the process proceeds to step 74, where the individual candidate objects are recombined into character strings according to their position within the original text sample. The individual candidate objects are then reassembled into character strings according to their position in the original text sample. Each of these character strings may have multiple touching character sequences (i.e. composite objects) that have undergone the fine segmentation process described above. In such a case, a candidate segmentation is formed for each possible combination of complete sets among the various composite objects. For example, in a character string with two composite objects, the first composite object will be represented by each of its complete region sets in multiple candidate segmentations. Each of these segmentations will have the second composite object represented by one of its complete sets. The character string will thus have a number of candidate segmentations equal to the product of the number of region sets produced for each sequence of touching characters. An overall score is then calculated for each candidate segmentation. Various methods may be used to calculate this value, but in the example embodiment, the overall score is the sum of the scores of the individual region sets. The candidate segmentations are ranked according to their overall score.

At step 76, the classifier classifies the highest-ranking candidate segmentation to obtain a string of alphanumeric characters. The identified character string is passed to an acceptor at step 78. At step 80, the acceptor determines if the character string is a valid character string for a particular application. For example, the acceptor may match various character strings to a list of approved character strings, such as a standard dictionary. The acceptor may further use contextual cues to determine if various character strings are appropriate given the surrounding character strings. For example, where the character strings are words, the acceptor may use various grammatical and syntactical rules to determine if a word belongs in a particular location. The specifics of a context matching approach will vary according to the application and the nature of the character strings.

If the acceptor rejects a particular candidate segmentation, the process returns to step 76, where the classifier selects the highest-ranking candidate segmentation that has not yet been rejected by the acceptor. The classifier reclassifies the character string using the new candidate segmentation to provide a new result for the acceptor. If the acceptor recognizes the input set as valid, the character combination is accepted and outputted by the system. The system then returns to step 58. If no further character blocks are available, the process terminates at step 78.

FIG. 5 illustrates an example embodiment 100 of the invention implemented as a computer program running on a data processor within a mail-processing system. It will be understood that the components shown in FIG. 5 are merely functional representations of routines and functions within the computer program. Further, functions carried out by the computer program, but not helpful in understanding the claimed invention, will not be shown in this diagram. A functional program, for example, would require some amount of temporary memory and routines for accessing this memory. Such matters are understood by those skilled in the art and they are omitted in the interest of brevity.

Turning to FIG. 5, a text sample, representing a mailing address scanned from a mailed envelope, is received at a segmentation portion 110 at a preprocessing portion 111. In the example embodiment, the text would be a mailing address, extracted from a scanned image of an envelope. The preprocessing portion 111 removes obvious noise from the text and converts it to a binary image consisting solely of uniform light and dark pixels. The preprocessed images are then passed to a coarse segmentation portion 112 that divides the text into lines, and then further into individual characters. Touching characters will not be properly separated and will remain as individual candidate objects, referred to as composite objects. Composite objects are identified by one or more preliminary classifiers (not shown) that determine if a candidate object is likely to contain touching characters.

Segmentation, even by the method of the present invention, frequently results in errors when dealing with particular difficult sequences. The preclassifier is trained to recognize these character sequences directly, just as it would a single character. This is intended as a specific classifier for accommodating particularly stubborn touching character sequences. Examples of these difficult character sequences include “fi”,“ff”, “ffi”, “rn”, “rt”, “tt”, and “TT”

The identified composite objects are then passed to a fine separation portion 113. The fine segmentation portion 113 determines appropriate locations at which to define boundary lines within each of the composite objects. In the example embodiment, this is accomplished via a least cost path algorithm. In the least cost path algorithm of the example embodiment, the composite object is divided into an interior portion and an exterior portion. The division between these portions is determined as the uppermost contour defined by the dark pixels within the composite object. The calculation of least cost begins at the bottom boundary of the composite object image and proceeds upward to the upper boundary in increments of one pixel. Accordingly, all boundary lines drawn in the present invention will be roughly vertical, running between the upper and lower boundaries of the composite object. The determined line may progress from a starting pixel in only three directions, either toward the pixel on its upper left, the pixel immediately above it, or the pixel on its upper right. As would be apparent, where the line reaches a pixel on the left or right boundary, the options for movement drop to two directions, as the line cannot leave the boundaries of the composite object image.

Each pixel has an associated cost. For example, light pixels will have a lower cost than dark pixels to discourage excessive segmentation of the characters. Similarly, the cost of a pixel will be affected by whether the pixel is located within the interior or the exterior portion of the composite object. The cost of each movement between pixels is a function of the cost of the pixel and the direction of movement. For example, diagonal movements are defined to be more expensive than vertical movements. This has the effect of keeping the split lines roughly vertical.

The fine segmentation portion 113 represents the image as a cost matrix. The construction of the cost matrix begins by filling the bottom row with the appropriate pixel costs. Each pixel in the next row of the matrix is assigned the smallest total cost value necessary to reach that pixel. Each pixel can only be reached from the three pixels beneath it in the previous row, so the system evaluates the cost of moving to the new pixel from each of those positions. Since each pixel of the previous row already contains the minimum cost necessary to reach it, the total cost at each new pixel may be defined by adding the cost of the new move to the previous values of each of the three starting pixels, and selecting the minimum total cost.

Once the cost matrix is filled, the system will determine one or more paths of lowest cost. In the example embodiment, paths are weighted as to their distance from the left and right boundaries to discourage trivial paths at the boundaries. Paths drawn near an existing boundary line are similarly weighted. The paths are selected by selecting the pixel in the top row with the smallest cost value and tracing the determined low cost path back to the bottom row. When the first lowest cost path is selected, the values of the other paths are weighted according to their proximity to the new line. This continues until the cost of new lines exceeds a predetermined cost value or a predetermined number of the best lines may be selected.

The fine segmentation portion 113 defines a number of regions, with a region being defined as the area defined by any two boundary lines, including the left and right exterior boundaries of the composite object. A separate image of each region is created and sent to the preclassifier 114.

At the preclassifier 114, the various regions are classified and assigned both an output class and an associated score. In the example embodiment, the preclassifier comprises multiple classifiers, including statistical and neural network classifiers. These classifiers determine an overall score for each region based upon the accuracy of the classification and the characteristics of the boundary lines defining the region.

Once a score has been determined for each region, the regions are formed into complete region sets by a region evaluation portion 115. A complete region set is a set of regions that contains the entire area between the exterior boundaries of a composite object exactly once. For example, a complete region set cannot contain both the region bounded by lines “b” and “d” and the region bounded by lines “c” and “e”, as this would result in overlap of the area bounded by lines “c” and “d”. Likewise, no area of the composite object may be omitted. Under this definition, the regions defined by X boundary lines combine to form 2^{X} complete sets.

Once the complete region sets are formed, the region evaluation portion 115 assigns to each an associated set score. In the example embodiment, the set score of a set is calculated by summing the associated scores of each of the regions in the set. The individual candidate objects are then reassembled into character strings according to their position in the original text sample. Each of these character strings may have multiple touching character sequences that have undergone the fine segmentation process described above. In such a case, a candidate segmentation is formed for each possible combination of complete sets among the various composite objects. The character string will have a number of candidate segmentations equal to the product of the number of region sets produced for each sequence of touching characters. An overall score is then calculated for each candidate segmentation. Various methods may be used to calculate this value, but in the example embodiment, the overall score is the sum of the scores of the individual sets.

The various candidate segmentations are then ranked according to their overall score, with the sets with the lowest score receiving the highest ranking in the example embodiment. In the example embodiment, all of the candidate segmentations are selected for input to the classifier. In an alternate embodiment, a predetermined number of candidate segmentations having the highest ranking will be selected. In a third embodiment, all candidate segmentations are passed except for those having a score greater than a threshold.

The selected candidate segmentations will be provided to the classification portion 120 at a classifier 121. The classifier 121 selects the highest-ranking candidate segmentations and classifies each character within the character string according to that segmentation to obtain-a series of alphanumeric characters as output.

The character strings identified by the classifier will typically be words, but depending on the application, these strings may be sequences of numbers, or combinations of letters, numbers, and miscellaneous characters. The identified character strings are provided to an acceptor 122 that compares the classified character string to a database of acceptable character strings for a given application. The acceptor 122 may also utilize contextual cues in accepting or rejecting individual words. For example, where the character strings are standard words, the acceptor 122 will use basic rules of grammar and syntax to determine if a classified word is appropriate in the context of surrounding words.

When the acceptor determines that a particular character string is invalid, the combination is rejected and an error message is provided to the classifier 121. The classifier 121 will then select the next highest-ranking segmentation from the list of candidate segmentations and provide a second classification result to the acceptor 122. In a preferred embodiment, when the character string contains multiple touching character sequences, the acceptor 122 may provide information to the classifier 121 to aid in determining the touching character sequence that is incorrectly segmented. In this embodiment, information as to the ranking of the individual regions sets for each segment is retained and sent to the classifier 121 to allow the segmentation of a particular touching character sequence to be changed without affecting the remainder of the string.

The process continues until either an identified character string is accepted, or the classifier 121 has attempted to classify each of the candidate segmentations provided. In such a case, an error message is issued to an operator and another text sample is processed.

In the example embodiment, the character strings comprise fields within the original mailing address. These fields are compared to an Address Resolution Module 123 within the acceptor 122 to determine if each of the fields is valid. Valid strings within a field will be retained without change, while strings found to invalid for a particular field will be rejected by the acceptor 122 and returned to the classifier for a new determination based upon a different segmentation. For example, the Address Resolution Module 123 will contain a list of all valid zip codes. Where the determined zip code is not found on the list, the acceptor 122 will prompt the classifier 121 to select a new segmentation of the zip code field and reclassify the characters in that field. The acceptor will contain the names of the fifty states and their abbreviations, city names, street addresses, and similar information for comparison. In a preferred embodiment, fields can be cross-checked to ensure that a particular zip code matches the listed city and state or that a given street address exists within a particular city.

In the example embodiment, a recognition system incorporating the present invention must process millions of mail pieces from many countries on a daily basis. It therefore must be able to recognize a nearly limitless amount of font styles and typefaces such as serif, sans serif, and italicized fonts. Digitally scanned mail pieces will typically have 10-15% of the characters either touching or broken. Considerable care is required to re-create the intended representation so that successful mail delivery can occur. Nuances between these font styles force the segmentation routine of the system to be robust such that the correct split will likely be generated. Unfortunately, this will result in several possible paths through the space must be generated including bad paths.

The segmentation approach of the example embodiment is based on the premise that the “correct” cutting paths through any touching character sequence will be generated. Then rankings generated above may then be used to enumerate the various split possibilities in order of their feasibility. The highest rank solution will be evaluated first, the second highest will be evaluated next, and so forth. The approach of allowing several potential split paths allows the system to segment correctly nearly any font type since absolute choices are not forced at the segmentation stage. Instead, we allow a myriad of choices and let our classifier deduce which are most applicable.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for classifying a character string, comprising:
determining a plurality of candidate segmentations for the character string, each ranked according to an associated score;
providing at least two of the candidate segmentations to a pattern recognition classifier;
classifying the character string according to the highest-ranked candidate segmentation to obtain a first classified character string;
determining if the first classified character string is a valid character string; and
iteratively reclassifying the character string according to the ranked candidate segmentations until a valid character string is obtained if the first classified character string is not a valid character string.

2. A method as set forth in claim 1, wherein the step of determining if the classified character string is a valid character string includes comparing the character string to at least one of a plurality of valid character strings.

3. A method as set forth in claim 1, wherein the step of determining if the character string is a valid character string includes evaluating the character string in relation to surrounding character strings.

4. A method as set forth in claim 1, wherein the character string includes at least one composite object representing a touching character sequence and the step of determining a plurality of candidate segmentations for a character string includes:
dividing a composite object within the character string into a plurality of regions;
classifying the plurality of regions to obtain an associated score for each region;
forming a plurality of complete region sets from the defined regions that represent a segmentation of the composite object;
defining a candidate segmentation from each of the complete region sets within the composite object.

5. A method as set forth in claim 4, wherein the character string includes a plurality of composite objects, each having a plurality of complete region sets, and a candidate segmentation is defined from each possible combination of complete sets among the plurality of composite objects.

6. A method as set forth in claim 5, wherein each of the complete region sets has an associated score derived from the associated scores of the regions from which it is formed.

7. A method as set forth in claim 6, wherein the associated score of the candidate segmentations is derived from the associated scores of the one or more complete sets from which it was defined.

8. A method as set forth in claim 1, wherein the character string is a part of a mailing address, digitally scanned from a mailed envelope.

9. A computer program product for classifying a character string, comprising:
a segmentation portion that determines a plurality of candidate segmentations for the character string, each ranked according to an associated score and outputs a set of at least two of the candidate segmentations;
a pattern recognition classifier that receives the outputted set of candidate segmentations and classifies the character string according to the highest-ranked candidate segmentation to obtain a first classified character string; and
an acceptor that determines if the first classified character string is a valid character string;
wherein the classifier iteratively reclassifies the character string according to the ranked set of candidate segmentations until a valid character string is obtained if the first classified character string is not a valid character string.

10. A computer program product as set forth in claim 9, wherein the acceptor compares the character string to at least one of a plurality of valid character strings.

11. A computer program product as set forth in claim 9, wherein the acceptor evaluates the character string in relation to surrounding character strings.

12. A computer program product as set forth in claim 9, wherein the character string includes at least one composite object representing a touching character sequence and the segmentation portion comprises the following:
a fine segmentation portion that divides a composite object within the character string into a plurality of regions;
a preclassifier that classifies the plurality of regions to obtain an associated score for each region; and
a region evaluation portion that forms a plurality of complete region sets from the defined regions that represent a segmentation of the composite object and defines a candidate segmentation from each of the complete region sets within the composite object.

13. A computer program product as set forth in claim 12, wherein the character string includes a plurality of composite objects, each having a plurality of complete region sets, and the region formation portion defines a candidate segmentation from each possible combination of complete sets among the plurality of composite objects.

14. A computer program product as set forth in claim 13, wherein each of the complete region sets has an associated score derived from the associated scores of the regions from which it is formed.

15. A computer program as set forth in claim 14, wherein the associated score of the candidate segmentations is derived from the associated scores of the one or more complete sets from which it is defined.

16. A computer program product as set forth in claim 9, wherein the character string is a part of a mailing address, digitally scanned from a mailed envelope.
